(19) United States
(12) Patent Application Publication
(10) Pub. No.: US 2005/0212240 A1
(43) Pub. Date: Sep. 29, 2005

(54) Racing sulky

(76) Inventors: Thomas Glen Harmer, Hinsdale, IL (US); Carl Calfin, Ann Arbon, MI (US)

Correspondence Address: BEEM PATENT LAW FIRM, 53 W. JACKSON BLVD., SUITE 1352, CHICAGO, IL, 60604-3787, US

(21) Appl. No.: 10/633,262

(22) Filed: Jul. 31, 2003

(51) Int. Cl. B62C 1/00

(52) U.S. Cl. 280/63

(57) ABSTRACT

A sulky to be drawn by a horse is provided that removes or lessons many problems with conventional sulkies including providing a means to align the wheels to ensure that they are aligned with the direction the horse is pulling the sulky, a novel wheel assembly with substantially planar wheel covers, a novel means of allowing the horse and the sulky to track independently of each other, and a novel means of offsetting the center line of the sulky from the center of the horse.

### BACKGROUND OF THE INVENTION

1. Field of the Invention

The present invention is directed to a horse drawn sulky, particularly to a racing sulky drawn by a horse in a harness racing competition.

2. Description of the Related Art

Horse racing with sulkies has been known for several millennia. However several problems still exist that decrease the speed and efficiency of the horse and sulky during a race.

The wheels of sulkies often are unaligned with respect to the longitudinal direction of travel. Wheels of sulkies are typically mounted after the sulky is assembled, and in many cases the wheels are not aligned, for example, the front of a wheel being closer to the center of the sulky than the back so that the wheel is angled inwardly, or vice versa, so that the wheel is angled outwardly, in either event creating a plowing effect that slows the horse. Many times this misalignment goes undetected and, even if detected, uncorrected.

Additionally, traditional sulkies have generally straight rails that are rigidly connected to an arch of the sulky. The straight and rigid rails can make it more difficult for the horse because the sulky tends to slide sideways during a turn as the sulky tends to be forced into a position directly behind the horse, i.e., to be forced by the harness and rails to the outside as the horse turns.

Attempts have been made to alleviate this problem, including U.S. Pat. No. 6,247,711, which uses pivotable wheels, and U.S. Pat. Nos. 4,863,180 and 5,183,279 which disclose a complicated connection between the rails and the arch that allows for lateral movement of the rails about a pivot axis. However, the pivoting assembly between the rail and the arch requires a complicated assembly of parts to work together to accommodate the lateral movement of the rails. The aforementioned sulkies may not meet the applicable standards of the United States Trotting Association Sulky Performance Standard, which is incorporated by reference as if reproduced herein.

Many sulkies have rails situated so that the center line between the rails is aligned with the center of the horse, but it is known that if the center line between the rails is offset toward the inside of the track, i.e., toward the left side of the sulky if the race is run counterclockwise or to the right if the race is run clockwise around a track, it moves the horse closer to the inside of the track so that the horse is permitted to run a shorter distance than with centered rails. International patent application WO 93/19969 discloses a sulky where the rails and the seat are shifted so that the center line of the rails and the seat are offset from the wheels. The “Time Machine” sulky, manufactured by Fab Weld, is believed to have included straight offset rails welded at right angles to the top of the arch. However, the geometry of the offset rails on the Time Machine sulky and those disclosed in WO 93/19969 tends to cause the pull on the sulky to be slightly uneven and also gives the sulky an unbalanced appearance.

The wheels of sulkies typically are wire-spoked. According to the United States Trotting Association Sulky Performance Standard, it is required to cover the spokes on both sides of the wheel to prevent the foot of the horse from stepping through the wheel. The wire-spokes of sulky wheels typically form a conical shape on each side of the wheel so that the wheel is wider at the axle than at the rims, such as in U.S. Pat. No. 5,857,686 and international patent application WO 93/19969. The wheel covers are also typically generally conical in shape to complement the wire spokes. However, conical wheel covers result in increased wind drag, slowing the horse during the race.

What is needed is a sulky that overcomes the problems associated with the prior art.

### BRIEF SUMMARY OF THE INVENTION

The inventive sulky includes a generally tubular arch having two ends, a seat mounted to the arch between the ends, a pair of strut assemblies depending downwardly from generally opposite ends of the arch, there being a wheel mounted to each strut assembly, a pair of rails mounted to the arch, one rail being mounted on one side of the seat and the other rail being mounted on the other side of the seat, each of the rails extending generally in a longitudinal direction from the arch to a distal end, the distal ends of the rails being adapted for harnessing the horse between the rails, a pair of supports, one support being connected to one of the rails at one end thereof and to one of the strut assemblies at the other end thereof and the other support being connected to the other rail at one end thereof and to the other strut assembly at the other end thereof, wherein the connection between each support and the corresponding rail is adjustable to allow for substantially longitudinal alignment of the wheels.

Also in accordance with the present invention, a novel sulky for being drawn by a horse is provided having a generally tubular arch having two ends, a seat mounted to the arch between the ends, a pair of strut assemblies depending downwardly from generally opposite ends of the arch, each strut assemblies for receiving a wheel, a pair of rails mounted to the arch, one rail being mounted on one side of the seat and the other rail being mounted on the other side of the seat, each of the rails extending generally in a longitudinal direction from the arch to a distal end, the distal ends being adapted for harnessing the horse between the rails, wherein the arch and the strut assemblies are positioned for substantially longitudinal alignment of the wheels prior to welding.

Also in accordance with the present invention, a novel sulky for being drawn by a horse is provided having a generally tubular arch having two ends, a pair of laterally spaced wheels mounted generally at opposite ends of the arch, a seat mounted to the arch between the ends and the wheels, a pair of rails mounted to the arch and extending forwardly, one of the rails being mounted to the arch on one side of the seat, and the other rail being mounted to the arch on the other side of the seat, each rail having a proximal portion mounted to the arch and a distal portion pivotally connected to the proximal portion so that the distal portion can pivot with respect to the proximal portion, each of the distal portions having a distal end adapted for harnessing the horse between the rails.

In another aspect of the invention, a novel sulky for being drawn by a horse is provided having a pair of laterally spaced wheels mounted generally at opposite ends of a generally tubular arch, there being a longitudinal center line between the pair of wheels, a seat mounted to the arch between the ends and the wheels, a first rail and a second rail extending from the arch, each rail having a proximal end mounted to the arch and a distal end adapted for harnessing to the horse, the first rail being mounted to the arch on one side of the seat and the second rail being mounted to the arch on the other side of the seat, wherein a portion of the first rail proximate the arch is angled toward the center line as the portion extends from the arch so that a longitudinal center line between the distal ends is offset from the longitudinal center line between the pair of wheels.

Also in accordance with the present invention, a wheel assembly is provided for a sulky to be drawn by a horse. The novel wheel assembly includes a wheel having two sides, a set of tubular spokes, and a rim, and a pair of substantially planar covers mounted on opposite sides of the wheel and substantially covering the tubular spokes. In another aspect of the invention, a pair of the novel wheel assemblies is mounted to generally opposite ends of an arch of a sulky.

### BRIEF DESCRIPTION OF THE SEVERAL VIEWS OF THE DRAWINGS

FIG. 1 is a perspective view of a sulky of the present invention.

FIG. 2 is an elevation view of the sulky of the present invention.

FIG. 3 is a plan view of the sulky of the present invention.

FIG. 4 is an elevation view of a connection between a support and a rail of the sulky in a first position.

FIG. 5 is an elevation view of the connection between the support and the rail of the sulky in a second position.

FIG. 6 is an elevation view of a hinge along the rail of the sulky.

FIG. 7 is a perspective view of the hinge along the rail of the sulky.

FIG. 8 is a partial sectional view of a wheel and substantially planar wheel cover of the sulky.

FIG. 9 is a close-up section view of the substantially planar wheel cover mounted to the wheel.

FIG. 10 is a cross-sectional view of an alternative embodiment of a connection between the support and the rail of the sulky in a first position.

FIG. 11 is a cross-sectional view of the alternative embodiment of the connection between the support and the rail of the sulky in a second position.

FIG. 12 is an elevation view of an alternative embodiment of a hinge along the rail of the sulky.

### DETAILED DESCRIPTION OF THE INVENTION

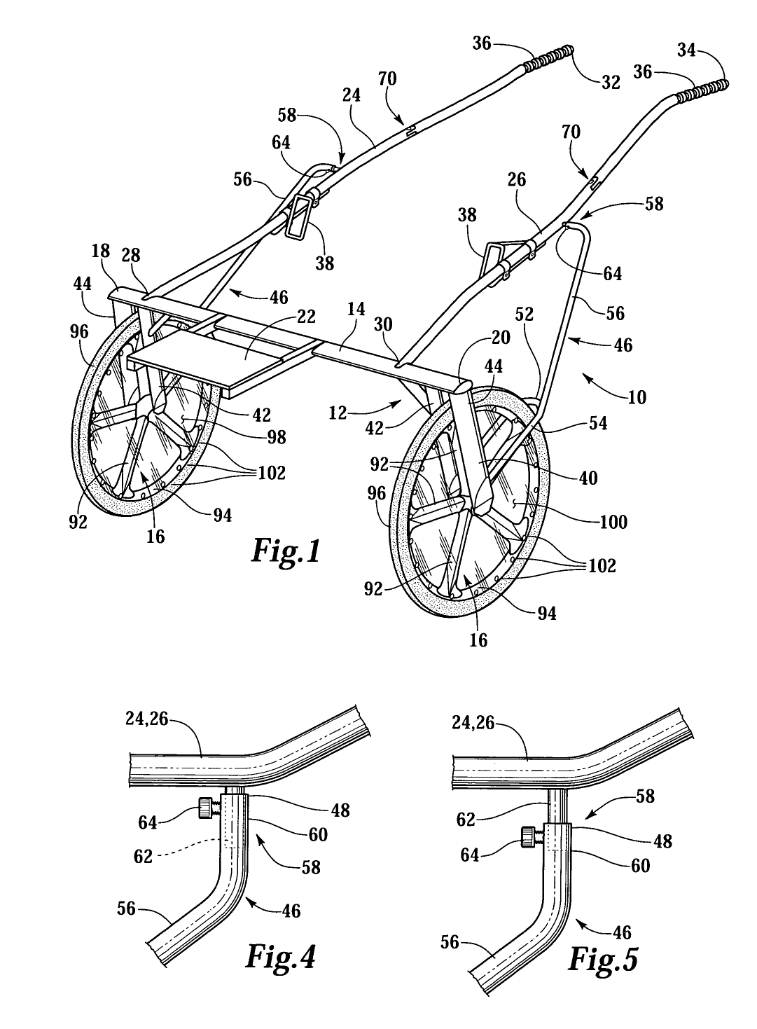

Referring to FIG. 1, a horse drawn sulky 10 is shown. Sulky 10 of the present invention includes several features that reduce drag and other resistances and that improve the efficiency of the horse during a harness racing competition.

Sulky 10 is designed with advantages particularly helpful in a racing sulky. Removing resistances, such as wind drag, to decrease the amount of work the horse needs to exert is important during a race. Also, it is important to provide for the efficient transfer of energy between the horse and the sulky in the racing direction.

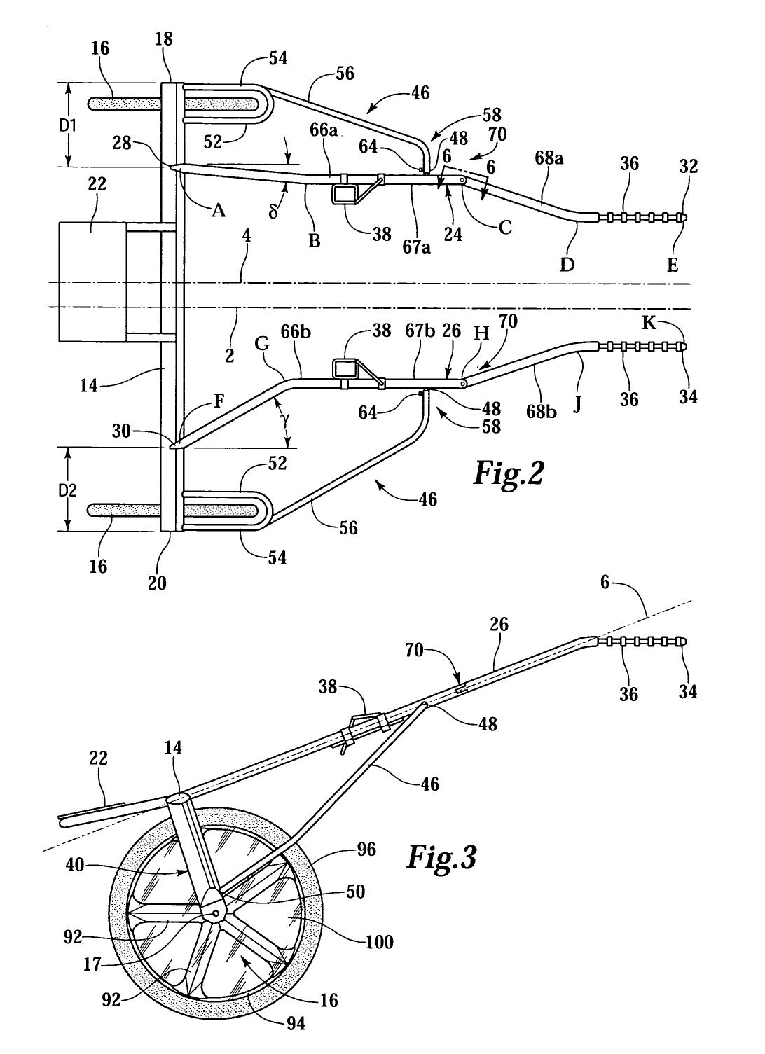

FIGS. 1 and 2 show a sulky 10 having a frame 12 with a generally tubular arch 14 with a pair of laterally spaced wheels 16 mounted generally at opposite ends 18, 20 of arch 14, with a center line 2 between wheels 16. A seat 22 is mounted on arch 14 between ends 18 and 20 for supporting a driver. In one embodiment, seat 22 is cantilevered to arch 14. In a preferred embodiment, shown best in FIGS. 1 and 3, arch 14 is streamlined to have an aerodynamic shape to reduce air resistance drag on sulky 10.

Sulky 10 also includes a pair of rails 24, 26 having proximal ends 28, 30 mounted to arch 14 and extending forwardly generally in the longitudinal direction of center line 2 to distal ends 32, 34. One of the rails is mounted on one side of seat 22 and the other rail is mounted on the other side of seat 22. For example, proximal end 28 of rail 24 is mounted on the left side of seat 22 and proximal end 30 of rail 26 is mounted on the right side of seat 22. Preferably, rails 24, 26 extend generally in a common rail plane 6, best seen in FIG. 3. Distal ends 32, 34 are adapted for harnessing to a horse between rails 24, 26. Distal ends 32, 34 can be harnessed to the horse by several conventional means, such as by bullets 36 shown in FIG. 2. There should be enough bullets 36 to allow for adjustable harnessing of the horse. In a preferred embodiment, there are more than three bullets, preferably six (as shown in FIG. 2) or seven bullets 36. A stirrup 38 is connected to each rail 24, 26 between proximal end 28, 30 and distal end 32, 34. In a preferred embodiment, stirrups 38 can be adjusted along generally parallel portions 67a, 67b of rails 24, 26 to accommodate drivers of different heights.

In one embodiment, best seen in FIGS. 1 and 8, each wheel 16 is mounted proximate an end 18, 20 of arch 14 by a strut assembly 40. Each strut assembly 40 includes an inner strut 42 and an outer strut 44, wherein the wheel 16 is mounted on an axle 17 extending between inner strut 42 and outer strut 44 so that wheel 16 is mounted between inner strut 42 and outer strut 44. Axle 17 can be mounted to strut assembly 40 by a conventional nut, or by a quick-release mechanism. Preferably, inner strut 42 and outer strut 44 are streamlined, as shown best in FIG. 1, to reduce drag on sulky 10.

Turning to FIGS. 1, 2 and 3, sulky 10 can also include a pair of supports 46, each being mounted to a corresponding rail 24, 26 at a first end 48 and a corresponding strut assembly 40 at a second end 50. In one embodiment, supports 46 are fork assemblies having a main portion 56 mounted to rail 24, 26 that splits into an inner leg 52 and an outer leg 54 near wheels 16, wherein inner leg 52 connects to inner strut and outer leg 54 connects to outer strut 44.

Aligned Wheels

Sulky 10 of the present invention provides aligned wheels 16 that are substantially longitudinally aligned with center line 2, which corresponds to the direction the horse is pulling sulky 10. Sulky 10 ensures wheels 16 are aligned by either providing for adjustment of the wheels or by welding strut assemblies 40 to arch 14 and rails 24, 26 to arch 14 in a jig to ensure that wheels 16 will be aligned.

The alignment of wheels 16 is determined mainly by the orientation of strut assemblies 40 and rails 24, 26 in relation to arch 14. If strut assemblies 40 or rails 24, 26 are not oriented properly with arch 14, it is difficult to make wheels 16 aligned. Much of the alignment of strut assemblies 40 occurs during the manufacture of a sulky, however, sulky 10 advantageously provides for adjustments of wheels 16 after sulky 10 has been assembled.

Turning to FIGS. 2, 4 and 5, in one embodiment, sulky 10 includes a tubular arch 14 having two ends 18, 20, a seat 22 mounted to arch 14 between ends 18, 20, a pair of strut assemblies 40 depending downwardly from generally opposite ends 18, 20 of arch 14, there being a wheel 16 mounted to each strut assembly 40, a pair of rails 24, 26 mounted to arch 14, one rail 24 being mounted on one side of seat 22 and the other rail 26 being mounted on the other side of seat 22, each rail 24, 26 extending generally in a longitudinal direction from arch 14 to a distal end 32, 34, a pair of supports 46, one support being connected to one rail 24 at one end thereof and to one of the strut assemblies 40 at the other end thereof, and the other support 46 being mounted to the other rail 26 at one end thereof and to the other strut assembly 40 at the other end thereof.

Sulky 10 includes an adjustable connection 58 between support 46 and rail 24, 26 at first end 48 to allow for alignment of wheels 16 in the longitudinal direction of center line 2. In one embodiment, shown in FIGS. 4 and 5, adjustable connection 58 includes a sleeve 60 at first end 48 of support 46 and an arm 62 connected to rail 24, 26. Both arm 62 and sleeve 60 are generally tubular wherein arm 62 has an outer diameter that is slightly smaller than the inside diameter of sleeve 60 so that sleeve 60 can slide along arm 62 to change the length of adjustable connection 58. Adjustable connection 58 also includes a locking means, such as a set screw 64 or other fastener, to lock sleeve 60 in place relative to arm 62. When set screw 64 is in a tightened mode, sleeve 60 is fixed so that it cannot move relative to arm 62, and when set screw is in an untightened mode, sleeve 60 is free to slide along arm 62.

As shown in FIGS. 1-3, supports 46 are connected to strut assemblies 40 at second ends 50. As sleeve 60 at first end 48 slides along arm 62, it moves support 46 inwardly toward center line 2, or outwardly away from center line 2. Because of the connection between support 46 and strut assembly 40, as the support moves inwardly or outwardly, strut assembly 40 is directed either toward center line 2 or away from it. For example, if it is determined that the right wheel 16 is misaligned so that the front of the wheel is pointing inwardly, set screw 64 can be loosened and sleeve 60 can be slid outwardly along arm 62. As sleeve 60 slides outwardly, support 46 also moves outwardly, causing strut assembly 40 to be directed slightly in a clockwise direction as you are looking down on sulky 10. Sleeve 60 slides outwardly until right wheel 16 is aligned properly, and set screw 64 is retightened to lock sleeve 60 with respect to arm 62.

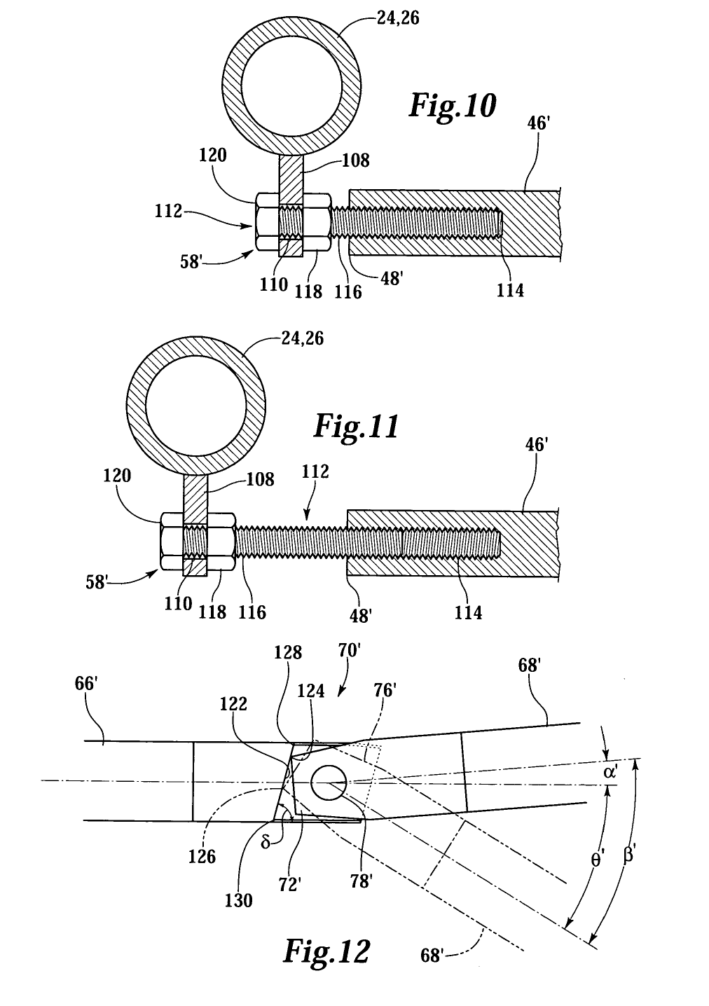

Turning to FIGS. 10 and 11, an alternative embodiment of adjustable connection 58′ is shown. Adjustable connection 58′ includes a flange 108 extending from rail 24, 26, wherein flange 108 has a bore 110 through which an adjustable fastener, such as a bolt 112, can be extended. Supports 46′ include a threaded hole 114 for receiving the threaded shank 116 of bolt 112. Support 46′ can be adjusted inwardly or outwardly, i.e. right to left in FIGS. 10 and 11, by rotating bolt 112. Hole 114 can receive a significant portion of bolt shank 116, as shown in FIG. 10, so that first end 48′ of support 46′ is relatively close to rail 24, 26, which aligns the front of wheel 16 inwardly. Bolt 112 can be rotated, i.e., manually or with a rotary driving tool such as a wrench, so that the threads of shank 116 engage with the threads of hole 114, forcing first end 48′ of support 46′ away from rail 24, 26, as shown in FIG. 11, thereby aligning the front of wheel 16 outwardly. A nut 118 can also be engaged with shank 116 to clamp flange 108 between the head 120 of bolt 112 and nut 118 in order to keep bolt 112 fixed relative to flange 108.

In another embodiment of the invention, sulky 10 is manufactured to ensure that strut assemblies 40 and wheels 16 are properly aligned with arch 14, rails 24, 26 and center line 2. To ensure that wheels 16 are aligned, strut assemblies 40 and arch 14 are placed in a jig (not shown), and strut assemblies 40 and arch 14 are positioned with the jig to ensure that strut assemblies are oriented so they are substantially normal to arch 14 prior to attaching strut assemblies 40 and arch 14 together, such as by welding or other attaching means. The jig positions arch 14 and strut assemblies 40 to ensure substantially longitudinal alignment of wheels 16 with rails 24, 26 and center line 2 before welding sulky 10 together. After alignment is confirmed, the pieces are attached, such as by welding, so that the strut assemblies and the arch 14 are aligned properly.

A similar method can be applied to ensure that the rails 24, 26 are oriented properly with respect to arch 14. Arch 14 and each rail 24, 26 are placed in a jig (not shown), and rails 24, 26 and arch 14 are aligned by the jig to ensure that arch 14 and rails 24, 26 are oriented properly, before rails 24, 26 are welded to arch 14.

Each alignment and welding step, i.e., between strut assemblies 40 and arch 14, and between arch 14 and rails 24, 26 can be performed separately, with a separate jig for each alignment and welding step, or a combined jig can be used to align all the pieces together at essentially the same time.

Wheel Covers

Turning to FIGS. 1, 8, and 9, in another aspect of sulky 10 of the present invention, sulky 10 includes generally tubular arch 14 having two ends 18, 20, seat 22 mounted to arch 14 between ends 18, 20, a pair of rails, an inside rail 24 being mounted to arch 14 on the left side of seat 22, as shown in FIG. 2, the other outside rail 26 mounted to arch 14 on the right side of seat 22, wherein rails 24, 26 extend in a generally longitudinal direction from arch 14 to distal ends 32, 34 adapted for harnessing the horse between rails 24 and 26, a pair of laterally spaced wheel assemblies 87 mounted generally at opposite ends of arch 14, the wheel assemblies being designed to minimize drag due to air resistance. Each wheel assembly 87 includes a wheel 16 having an inside side 88, an outside side 90, a set of tubular spokes 92, a rim 94, a pair of substantially planar covers 98, 100 with an inside cover 98 being mounted on inside side 88 of wheel 16 and an outside cover 100 being mounted on opposite side 90 of wheel 16 for substantially covering spokes 92.

Tubular spokes 92 are larger than wire spokes so that each spoke 92 is stronger and can support more weight than a wire spoke. Also each spoke 92 is only wide enough between sides 88 and 90 to support the desired weight, but is not so wide that spokes 92 protrude past rim 94, so that no part of wheel 16 is wider than rim 94 and tire 96. Preferably, spokes 92 are flattened somewhat, having a generally oval or elliptically shaped cross section, as is best seen in FIG. 1, to ensure that spokes 92 are narrower than rim 94. Spokes 92 allow covers 98, 100 to be substantially planar, as shown in FIGS. 8 and 9, so that wheels 16 have a generally flat or substantially vertical planar profile, greatly reducing the drag on wheels 16, and hence on sulky 10. It has been found that wheels 16 with substantially planar covers 98, 100 allows for a decrease in drag of as much as four pounds or more at 30 miles per hour, allowing a horse to run about three or more lengths faster, per mile, than with conventional wheels.

Preferably there are five tubular spokes 92, as is shown in FIG. 1, evenly spaced around wheel 16 so that rim 94 and tire 96 are evenly supported. An example of a suitable wheel that can be used with sulky 10 is the Select K wheel manufactured by Bontrager Wheelworks and Components.

Covers 98, 100 are mounted to wheel 16, such as by a plurality of fasteners 102, such as Allen headed screws, shown in FIG. 1. Enough fasteners 102 should be used to ensure that covers 98, 100 are securely connected to wheels 16. In one embodiment, between 5 and 30, preferably between 10 and 20, still more preferably 15 fasteners, per cover, are used to mount covers 98, 100 to wheels. Preferably, fasteners 102 are mounted evenly and equidistantly around wheels 16 so that no portion of a cover 98, 100 protrudes out from rim 94, creating an uneven drag on wheel 16. In one embodiment, covers 98, 100 are mounted to rims 94 of wheels 16.

It is preferred that covers be removable so that they can be interchanged onto one or more wheels, and to allow for maintenance, such as refilling tires 96, or replacement of a wheel 16 or cover 98, 100. In one embodiment, covers 98, 100 are mounted to wheels 16 using Velcro 104 on covers 98, 100 and complementary Velcro 106 on wheel 16, best seen in FIG. 9, or other mounting means. In one embodiment, Velcro 106 is mounted on rim 94. Preferably Velcro 104 and 106 have a width that substantially covers the thickness of rim 94. Velcro 104, 106 should be mounted around enough of the circumference of rim 94 to ensure that covers 98, 100 remain mounted to wheel 16 during a race. In one embodiment, rim 94 has a thickness of between about ⅜ inch and about ½ inch, and Velcro 104, 106 has a width of between about ¼ inch and about ⅜ inch, preferably about ⅜ inch to cover a significant portion of rim 94. Also, preferably Velcro 106 covers substantially the entire circumference of rim 94.

In a preferred embodiment, covers 98, 100 are mounted to wheel 16 so that covers 98, 100 are substantially recessed beneath the edge of tire 96, preferably so covers 98, 100 are flush or below the edge of tire 96, as is shown in FIG. 9. Recessed covers 98, 100 are preferred so that covers 98, 100 do not protrude past tires 96, reducing the likelihood that covers 98, 100 will interfere or strike an obstruction, such as another sulky's wheel or debris or some other obstruction on the racetrack, and to minimize the drag created by covers 98, 100.

Covers 98, 100 are preferably made out of plastic or other resilient materials. Covers 98, 100 can be solid, opaque, colors, but preferably covers 98, 100 are transparent. Covers 98, 100 should be durable enough to withstand bumping by other sulkies, or kicking by a horse. Also, the material of covers 98, 100 should be chosen to minimize the noise transmitted between covers 98, 100 and wheels 16, as a horse racing track can be very bumpy and full of divots due to the hooves of several horses running on a dirt race track.

Offset Rails

Turning to FIG. 2, sulky 10 of the present invention can also include a novel configuration of rails 24, 26 so that a center line 4 between distal ends 32, 34 of rails 24, 26 are offset from the center line 2 between wheels 16. Preferably rail center line 4 is offset toward the inside of the track from wheel center line 2, i.e., toward the left side, as shown in FIG. 2, if the race is run in a counterclockwise direction or toward the right side if the race is run in a clockwise direction. Offset rails 24, 26 allow the horse to be positioned closer to the inside of the track during a race, which lessens the actual distance the horse has to run.

Continuing with FIG. 2, inside rail 24 includes point A at proximal end 28, bend B in the racing direction from point A, pivot point C in the racing direction from bend B, bend D in the racing direction from point C, and point E at distal end 32. Outside rail 26 includes point F at proximal end 30, bend G in the racing direction from point F, pivot point H in the racing direction from bend G, bend J in the racing direction from point H, and point K at distal end 34.

Portion AB of inside rail 24 proximate to arch 14 is angled toward center line 2 at an angle δ as portion AB extends from arch 14 toward distal end 28. Portion FG of outside rail 26 proximate arch 14 is angled toward center line 2 at an angle γ as portion FG extends from arch 14 toward distal end 30. Angle γ is larger than angle δ of portion AB of inside rail 24, so that center line 4 between distal ends 32, 34 is offset from center line 2 between wheels 16.

Preferably portion BC of inside rail 24 is substantially parallel to portion GH of outside rail 26, and to center lines 2 and 4 so that when stirrups 38 are adjusted along rails 24, 26, the stirrups remain generally the same distance apart.

In one embodiment, angle γ of portion FG is between 15° and 45°, preferably between 20° and 35°, still more preferably about 30°, while angle δ of portion AB is between 0° and about 20°, preferably between about 3° and about 10°, still more preferably about 5°. The distance D1 between inside end 18 of arch 14 and proximal end 28 of inside rail 24 is preferably substantially equal to the distance D2 between outside end 20 and proximal end 30 of outside rail 26 so that the pull experienced by arch 14 by rails 24, 26 is generally equal and balanced. Also, the substantially equal distances D1, D2 between proximal ends 28, 30 and arch ends 18, 20 give sulky 10 an even and balanced appearance.

Hinged Rails

Continuing with FIG. 2, in another embodiment sulky 10 includes rails 24, 26 that are hinged to allow generally independent tracking of the horse and sulky 10, so that the sulky will not tend to slide sideways in a turn.

Hinged inside rail 24 includes a proximal portion 66a between points A and C mounted to arch 14 on the inside, or left, of seat 22 and a distal portion 68a between points C and E pivotally connected to proximal portion 66a so that distal portion 68a can pivot in rail plane 6 with respect to proximal portion 66a. Similarly, hinged outside rail 26 includes a proximal portion 66b between points F and H mounted to arch 14 on the outside, or right, of seat 22 and a distal portion 68b between points H and K pivotally connected to proximal portion 66b so that distal portion 68b can pivot substantially in the rail plane 6 with respect to proximal portion 66b. Distal portions 68a, 68b preferably pivot through a generally lateral arc to permit lateral tracking of sulky 10 as the horse turns. Distal portions 68, 68b are adapted for harnessing the horse between rails 24, 26.

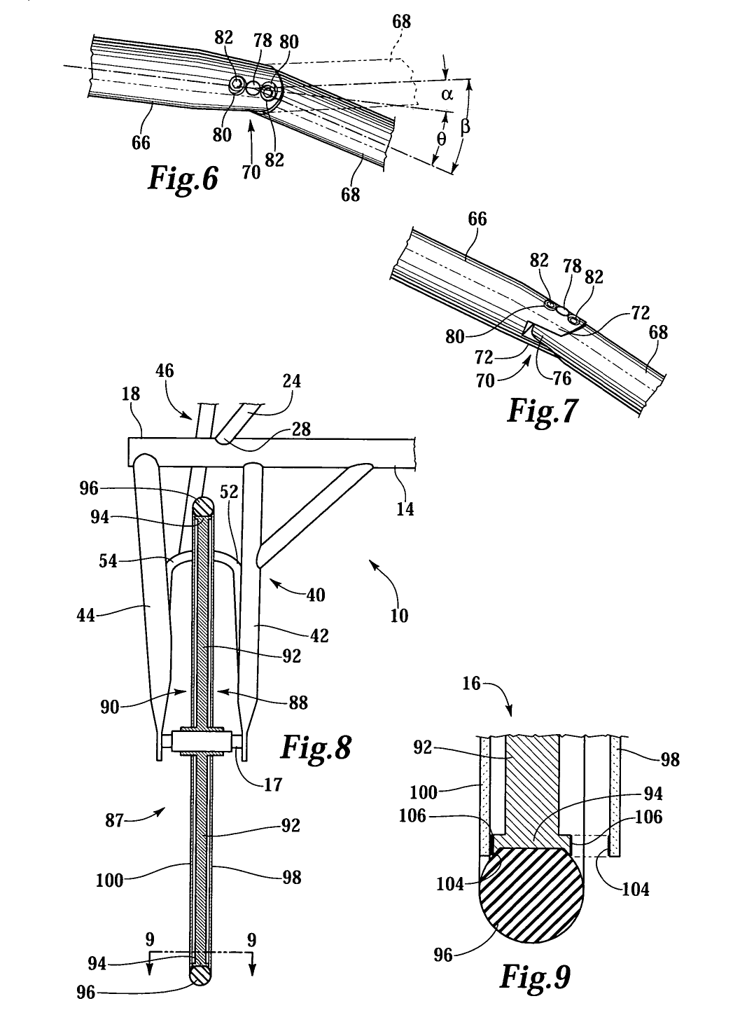

Turning to FIGS. 6, 7 and 12, in a preferred embodiment, distal portions 68, 68b are pivotally connected to proximate portions 66, 66′ by a hinge 70, 70′, wherein hinge 70, 70′ allows the pivotal motion of distal portion 68, 68′ generally within rail plane 6. Preferably, hinge 70, 70′ is adapted to only allow distal portion 68, 68′ to pivot over a limited range with respect to proximal portion 66, 66′ so that rails 24, 26 will not be difficult for the driver to control.

In one embodiment, shown in FIGS. 6 and 7, one of the portions 66, 68 (proximal portion 66 in FIG. 7) includes one or more wings 72 that frame a recess 74, while the other portion 66, 68 (distal portion 68 in FIG. 7) includes a complementary tongue 76 that abuts wings 72 and fits within recess 74, wherein wings 72 and tongue 76 are generally parallel to rail plane 6. A pivot pin 78 is inserted through wings 72 and tongue 76, wherein pivot pin 78 is generally normal to rail plane 6 so that distal portion 68 will pivot generally within rail plane 6. One of the wings 72 also includes a pair of oblong holes 80 longitudinally spaced slightly from pivot pin 78. A set screw 82 is mounted through each hole 80 onto tongue 76 so that the heads of set screws 82 are in holes 80. Holes 80 are oblong in a direction that allows the heads to slide along holes 80 as distal portion 68 pivots with respect to proximal portion 66. However, when each head reaches an end of a corresponding oblong hole 80, the distal portion 68 will not be able to continue pivoting in that direction with respect to proximal portion 66.

Turning to FIG. 6, in one embodiment, oblong holes 80 are cut into one of wings 72 in such a way to allow distal portion 68 to pivot inwardly toward the longitudinal direction of center line 2 (clockwise in FIG. 6) at an angle θ of between about 5° and about 45°, preferably between about 10° and about 30°, and still more preferably about 15° and holes 80 allow distal portion 68 to pivot outwardly from the longitudinal direction of center line 2 (counterclockwise in FIG. 6) at an angle α of between 0° and about 15°, preferably between about 2° and about 10°, still more preferably about 5°, so that the total range β in which distal portion 68 can pivot with respect to proximal portion 66 is a limited range of between about 5° and about 60°, preferably between about 10° and about 40°, and still more preferably about 20°.

In an alternative embodiment, shown in FIG. 12, wings 72′ have a generally angled off shape, as opposed to the rounded shaped of wings 72 shown in FIG. 6, and a wall 122 is included adjacent to tongue 46′. Angled wings 72′ include edges 124, 126 that come into contact with wall 122 so that distal portion 68′ will not be able to continuing pivoting with respect to proximal portion 66′. As shown in FIG. 12, wherein wings 72′ are on distal portion 68′ and wall 122 is on proximal portion 66′, distal portion 68′ can pivot from being angled outwardly at an angle α′ wherein outer edge 124 is in contact with wall 122 to being angled inwardly at an angle θ′ wherein inner edge 126 is in contact with wall 122. In a preferred embodiment, wall 122 is angled at an angle δ relative to the axis of proximal portion 66′ so that the outside end 128 of wall 122 is closer to distal portion 68′ than inside end 130 of wall 122, as shown in FIG. 12. An angled wall 122 is preferred so that inside angle θ′ is larger than outside angle α′, however, wall 122 could be angled in the opposite direction or wall 122 could be generally perpendicular to the axis of proximal portion 66′.

Preferably, hinges 70, 70′ allow distal portions 68, 68′ to pivot with respect to proximal portions 66, 66′ over enough of a lateral range to allow the horse pulling sulky 10 to have enough lateral freedom of movement around a turn. It has been found that a horse will use between about 1 inch and about 1½ inches of lateral movement relative to a sulky when negotiating a turn, therefore, it is preferred that hinges 70, 70′ of sulky 10 allow for at least this much lateral movement for the horse. However, too much lateral movement can allow the horse to turn too quickly and can make it difficult to control the sulky. In one embodiment, hinges 70, 70′ allow distal portions 68, 68′ to pivot so that distal ends 32, 34 laterally move over a predetermined total lateral range of between about 1 inch and about 1 foot, preferably between about 3 inches and about 6 inches, still more preferably between about 4 inches and about 4½ inches as distal portions 68, 68′ pivot with respect to proximal portions 66, 66′.

The sulky of the present invention removes or lessons many problems with conventional sulkies including providing a way to align the wheels to ensure that they are aligned with the direction the horse is pulling the sulky, a novel wheel assembly with substantially planar wheel covers, a novel way of allowing the horse and the sulky to track independently of each other, and a novel way of offsetting the horse from the center line between the wheels.

While the foregoing written description of the invention enables one of ordinary skill to make and use what is considered presently to be the best mode thereof, those of ordinary skill will understand and appreciate the existence of variations, combinations, and equivalents of the specific exemplary embodiment herein. The invention should therefore not be limited by the above described embodiments, but by all embodiments within the scope and spirit of the invention.

1. A sulky to be drawn by a horse, comprising:
a generally tubular arch having two ends;
a seat mounted to said arch between said ends;
a pair of strut assemblies depending downwardly from generally opposite ends of said arch, there being a wheel mounted to each of said strut assemblies;
a pair of rails mounted to said arch, one rail being mounted on one side of said seat and the other rail being mounted on the other side of said seat, each of said rails extending generally in a longitudinal direction from said arch to a distal end, said distal ends of said rails being adapted for harnessing said horse between said rails;
a pair of supports, one support being connected to one of said rails at one end thereof and to one of said strut assemblies at the other end thereof and the other support
being connected to the other of said rails at one end thereof and to the other of said strut assemblies at the other end thereof;
wherein the connection between each support and the corresponding rail is adjustable to allow for substantially longitudinal alignment of said wheels.

2. A sulky to be drawn by a horse, comprising:
a generally tubular arch having two ends;
a seat mounted to said arch between said ends;
a pair of strut assemblies depending downwardly from generally opposite ends of said arch, each of said strut assemblies for receiving a wheel;
a pair of rails mounted to said arch, one rail being mounted on one side of said seat and the other rail being mounted on the other side of said seat, each of said rails extending generally in a longitudinal direction from said arch to a distal end, said distal ends of said rails being adapted for harnessing said horse between said rails;
wherein said arch and said strut assemblies are positioned for substantially longitudinal alignment of said wheels before welding.

3. A sulky to be drawn by a horse, comprising:
a generally tubular arch having two ends;
a pair of laterally spaced wheels mounted generally at opposite ends of said arch;
a seat mounted to said arch between said ends and said wheels;
a pair of rails mounted to said arch and extending forwardly, one of said rails being mounted to said arch on one side of said seat, and the other of said rails being mounted to said arch on the other side of said seat, each rail having a proximal portion mounted to the arch and a distal portion pivotally connected to said proximal portion so that said distal portion can pivot with respect to said proximal portions;
each of said distal portions having a distal end adapted for harnessing said horse between said rails.

4. A sulky according to claim 3, wherein said distal end of each distal portion moves over a predetermined lateral range of between about 4 inches and about 4½ inches when said distal portion pivots with respect to said proximal portion.

5. A sulky to be drawn by a horse, comprising:
a pair of laterally spaced wheels mounted generally at opposite ends of a generally tubular arch, there being a longitudinal center line between said pair of wheels;
a seat mounted to said arch between said ends and said wheels;
a first rail and a second rail extending from said arch, each rail having a proximal end mounted to said arch and a distal end adapted for harnessing to said horse, said first rail being mounted to said arch on one side of said seat and said second rail being mounted to said arch on the other side of said seat;
wherein a portion of said first rail proximate said arch is angled toward said center line as said portion extends from said arch, and wherein a longitudinal center line between said distal ends is offset from said longitudinal center line between said pair of wheels.

6. A sulky according to claim 5, wherein said portion is angled at an angle of about 15 degrees.

7. A sulky according to claim 5, wherein said portion of said first rail proximate to said arch is angled at a first angle toward said center line as said portion extends from said arch and a portion of said second rail proximate said arch is angled at a second angled toward said center line as said portion of said second rail extends from said arch, wherein said first angle is larger than said second angle.

8. A sulky according to claim 7, wherein said first angle is about 15 degrees and said second angle is about 5 degrees

9. A sulky to be drawn by a horse, comprising:
a generally tubular arch having two ends;
a seat mounted to said arch between said ends;
a pair of rails, one rail being mounted to said arch on one side of said seat, the other rail being mounted to said arch on the other side of said seat, said rails extending in a generally longitudinal direction from said arch to distal ends, said distal ends of said rails being adapted for harnessing said horse between said rails;
a pair of laterally spaced wheel assemblies mounted generally at opposite ends of said arch;
wherein each of said wheel assemblies includes a wheel having two sides, a set of tubular spokes, a rim, and a pair of substantially planar covers mounted on opposite sides of said wheel and substantially covering said spokes.

10. A wheel assembly for a sulky to be drawn by a horse, comprising:
a wheel having two sides, a set of tubular spokes, and a rim; and
a pair of substantially planar covers mounted on opposite sides of said wheel and substantially covering said tubular spokes.

11. A wheel assembly according to claim 10, wherein said covers are mounted to said wheel using fasteners.

12. A wheel assembly according to claim 10, wherein said covers are mounted to said wheel using Velcro.

13. A sulky to be drawn by a horse, comprising:
a generally tubular arch having two ends;
a pair of laterally spaced wheels mounted generally at opposite ends of said arch;
a seat mounted to said arch between said ends and said wheels;
a pair of rails mounted to said arch and extending forwardly, one of said rails being mounted to said arch on one side of said seat, and the other of said rails being mounted to said arch on the other side of said seat, each rail having a proximal portion mounted to the arch and a distal portion pivotally connected to said proximal portion so that said distal portion can pivot with respect to said proximal portions;
each of said distal portions having a distal end adapted for harnessing said horse between said rails;
wherein said distal end of each distal portion moves over a predetermined lateral range of between about 4 inches and about 4½ inches when said distal portion pivots with respect to said proximal portion.
